(19) United States
(12) Patent Application Publication
(10) Pub. No.: US 2019/0315318 A1
(43) Pub. Date: Oct. 17, 2019

(54) Scraper Device

(71) Applicant: Orvie Wake, VANCOUVER, WA (US)

(72) Inventor: Orvie Wake, VANCOUVER, WA (US)

(21) Appl. No.: 16/106,605

(22) Filed: Aug. 21, 2018

Related U.S. Application Data
(60) Provisional application No. 62/657,085, filed on Apr. 13, 2018.

(51) Int. Cl. B60S 3/04; B08B 1/00; B25G 1/04

(52) U.S. Cl. CPC B60S 3/045; B25G 1/04; B08B 1/005

(57) ABSTRACT

A scraper device designed to aid a user in safely cleaning the bed of a truck. The scraper device has a rod with a first end and a second end, wherein the first end is opposite the second end. The rod is designed to be telescopic, such that a bottom portion of the rod is designed to retract into a top portion of the rod. A blade, having a top edge and a bottom edge parallel to one another such that a trapezoidal shape is formed, is attached to the rod such that the bottom edge of the blade is secured to the second end of the rod. In this way, a user can safely scrape clean the beds of trucks.

### CROSS REFERENCE TO RELATED APPLICATIONS

This application claims the benefit of U.S. Provisional Application No. 62/657,085 filed on Apr. 13, 2018. The above identified patent application is herein incorporated by reference in its entirety to provide continuity of disclosure.

### BACKGROUND OF THE INVENTION

The present invention relates to a scraper device configured to aid a user in safely cleaning a truck bed. More specifically, the present invention provides a telescopic rod, having a blade attached at one end.

Often when dump trucks are used to transport degradable materials such as dirt, concrete or rocks, the bed of the truck must be cleaned out after use. However, it can be difficult and unsafe for a user to clean out the truck bed. Individuals attempting to clean out the truck bed will often trip and fall when attempting to clean the truck bed. Often, individuals will injure themselves when attempting to climb into or out of the truck bed. Thus, there is a need for an improved scraper device that can help a user clean the bed of the dump truck safely.

### SUMMARY OF THE INVENTION

In view of the foregoing disadvantages inherent in the known types of scraper devices now present in the known art, the present invention provides a scraper device wherein the same can be utilized for providing convenience for the user when safely cleaning the bed of a truck.

The present system comprises a scraper device, further comprising a rod having a first end and a second end, wherein the first end is disposed opposite the second end. The rod is configured to be telescopic, such that a bottom portion of the rod is configured to retract into a top portion of the rod. A blade, having a top edge and a bottom edge disposed parallel to one another such that a trapezoidal shape is formed, is affixed to the rod such that the bottom edge of the blade is secured to the second end of the rod. In this way, a user can safely scrape clean the beds of trucks.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the scraper device extended.

FIG. 2 shows a close-up view of the blade of the scraper device.

### DETAILED DESCRIPTION OF THE INVENTION

Reference is made herein to the attached drawings. Like reference numerals are used throughout the drawings to depict like or similar elements of the scraper device. The figures are intended for representative purposes only and should not be considered to be limiting in any respect.

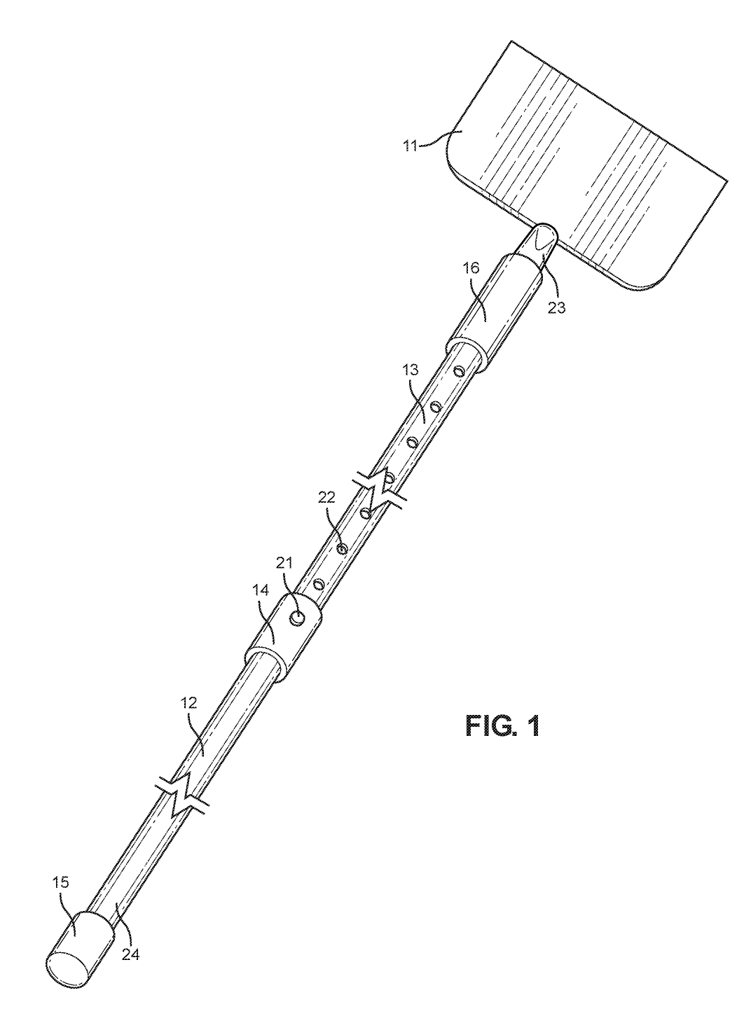

Referring now to FIG. 1, there is shown a perspective view of the scraper device extended. A scraper device comprises a rod, having a first end 24 and a second end 23, wherein the second end 23 is disposed opposite the first end 24. The rod is telescopic, such that it is movable between a retracted form and an extended form. The extended form is defined wherein a first portion of the rod and a second portion of the rod are expanded to a maximum length. The retracted form is defined wherein a first portion of the rod is disposed entirely within a second portion of the rod.

In the illustrated embodiment, the rod further comprises a top portion 12 at the first end and a bottom portion 13, wherein the bottom portion 13 is disposed at the second end 23. The top portion 12 is of a greater circumference than the bottom portion 13 such that the bottom portion is slidably movable therein. In this way, a user can reduce the length of the rod by storing the bottom portion 13 entirely inside the top portion 12, such that the rod is in the retracted form. Thus, in the retracted form the total length of the rod is shortened thereby allowing the user greater maneuverability and additionally aiding in storing the scraper device.

In the illustrated embodiment, the top portion 12 and the bottom portion 13 are joined together by a locking connector 14. The bottom portion 13 further comprises a plurality of apertures 22 disposed along a surface of the bottom portion 13. In the illustrated embodiment, each aperture of the plurality of the apertures 22 is aligned with one another along an axis and disposed at even intervals along the surface of the bottom portion 13, wherein the plurality of apertures 22 extends from the connector 14 to the second end 23 of the rod. In the shown embodiment, a locking pin 21 is disposed within the locking connector 14, wherein each aperture of the plurality of apertures 22 are configured to receive the locking pin 21 therein. In this way, the user can extend the bottom portion 13 of the rod to a desired length and lock it into place at the appropriate aperture 22 utilizing the locking pin 21. In other embodiments, a spring-biased push button is used in the locking connector 14.

In the illustrated embodiment, a handle 15 is disposed at the distalmost point of the first end 24 of the rod. The handle 15 is configured to be gripped by a user, and is composed of a material, such as rubber, to aid the user in frictionally grasping the handle 15. In one embodiment, the handle 15 comprises a groove configured to contour to the shape of a hand, further aiding the user in securely gripping the handle 15.

A blade 11 is secured to the second end 23 of the rod. In the illustrated embodiment, the blade 11 is affixed to the second end 23 of the rod via a fastener 16. In the illustrated embodiment, the fastener 16 comprises a reinforced hollow head configured to fit overtop the second end of the rod, such that the reinforced hollow head 16 is frictionally affixed to the second end 23 of the rod and securing the blade 11 to the rod. In other embodiments, however, the fastener 16 is threaded such that it screws onto the second end 23 of the rod.

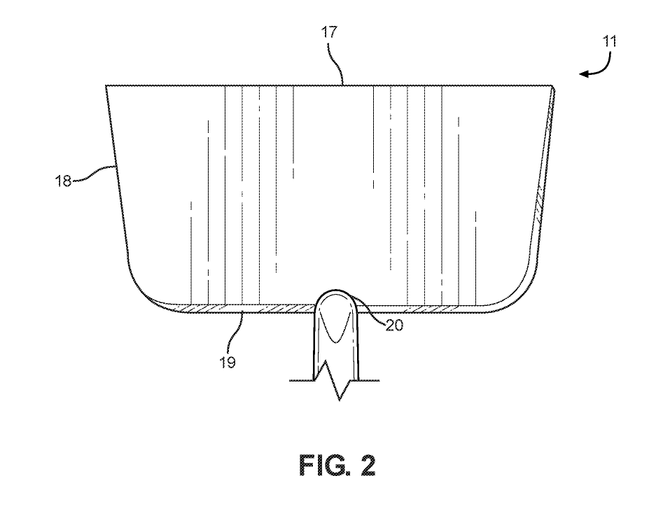

Referring now to FIG. 2, there is shown a close-up view of the blade of the scraper device. The blade 11 comprises a top edge 17 and a bottom edge 19 disposed parallel to one another such that a trapezoidal shape is formed. In the illustrated embodiment, the blade 11 is planar, such that a front face and a back face of the blade are flat, thereby allowing a user to easily maneuver the blade 11 across the bed of the truck. The trapezoidal shape of the blade 11 is an isosceles trapezoid, such that a pair of side edges 18 of the blade 11 are not parallel to one another but are equal in length.

In the shown embodiment, the top edge 17 of the blade 11 has a greater length between each side 18 than a length of the bottom edge 19 of the blade 11 between each side edge 18. Thus, each side edge 18 of the blade 11 is angled to extend outward from the bottom edge 19. In the illustrated embodiment, the angle created between each side edge 18 and the top edge 17 is equivalent to 80°, however in other embodiments the angle created between each side edge 18 and the top edge 17 is less than 80°. When the angle between the side edge 18 and top edge 17 is decreased, the top edge 17 becomes wider, thereby allowing the user to cover more surface area when using the scraper device.

In the shown embodiment, each corner where each side edge 18 connects to the bottom edge 19 is curved such that no sharp angles are produced. In this way, the blade 11 is made safer for a user, as sharp angles on the bottom edge 19 could cause injuries where a user pushes against the bottom edge 19. In the illustrated embodiment the fastener is affixed to the bottom edge 19 of the blade 11 through a connection 20. In the shown embodiment, the connection 20 comprises a weld or other suitably secure connection and is fastened to the bottom edge 19 at a center of the bottom edge 19 so as to provide adequate balance to the user when using the blade 11 and gripping the rod.

The top edge 17 of the blade 11 is sharpened, such that the top edge 17 provides convenience to the user by allowing for more efficient removal of debris from a bed of a truck. Particularly, removing debris that may be stuck to the bed of the truck may require the action of a sharpened edge to separate the debris therefrom. In one embodiment, the blade 11 is flexible to provide for greater maneuverability. However, in other embodiments, the blade 11 is rigid to provide for greater resistance when scraping debris from the truck.

In operation, a user, standing next to or in the bed of a truck, will adjust the total length of the scraper device to a desired length by extending the bottom portion of the rod from the top portion of the rod to a desired length, depending on the length of the truck bed. The user will select the aperture corresponding to the desired length and lock the bottom portion of the rod at the desired length using the locking connector. The user will grip the top portion of the rod at the handle and insert the blade attached to the distalmost end of the rod into the truck bed. The user can then use the top edge of the blade to scrape along the truck bed, thereby removing any debris.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A scraper device, comprising:
a rod, having a first end disposed opposite a second end;
a blade, having a top edge and a bottom edge parallel to one another such that a trapezoidal shape is formed;
wherein the bottom edge of the blade is affixed to the second end of the rod;
wherein the rod is telescopic.

2) The scraper device of claim 1, wherein the top edge of the blade is sharpened.

3) The scraper device of claim 1, wherein the blade is planar.

4) The scraper device of claim 1, wherein a top edge of the blade is wider than the bottom edge of the blade.

5) The scraper device of claim 1, wherein the rod further comprises a handle including a gripping material thereon.

6) The scraper device of claim 1, wherein the rod further comprises a top portion and a bottom portion, wherein the top portion is of a greater circumference than the bottom portion such that the bottom portion is slidably movable therein.

7) The scraper device of claim 6, wherein the top portion and bottom portion are joined to one another through a locking connector.

8) The scraper device of claim 7, wherein the locking connector comprises a locking pin, wherein the locking pin is configured to removably secure within a plurality of corresponding apertures disposed in the bottom portion.

9) The scraper device of claim 5, wherein the handle comprises a groove configured to contour to the shape of a hand.
